(19) United States
(12) Patent Application Publication
(10) Pub. No.: US 2012/0086195 A1
(43) Pub. Date: Apr. 12, 2012

(54) Advertising method on sport clothing

(76) Inventor: Eftim Cesmedziev, San Pedro, CA (US)

(21) Appl. No.: 12/924,889

(22) Filed: Oct. 7, 2010

(51) Int. Cl. B42D 15/00

(52) U.S. Cl. 283/67

(57) ABSTRACT

A officially recognized fan organization from all relevant organizations is advertised on the sport team clothes/apparel, where the fan advertise them self and as a return receive great discounts from the sport team supporters, creating healthy relation between sport fan, sport teams and sport supporters/sponsors.

### RELATED APPLICATION

Not applicable

### STATEMENT REGARDING STATE SPONSORED RESEARCH OF DEVELOPMENT

Not applicable

### NOTICE OD MATERIAL SUBJECT TO COPYRIGHT PROTECTION

A portion of the material in this patent document is subject to copyright protection under copyright laws of the United States and other countries. The owner of the copyright rights has no objection to the facsimile reproduction by anyone of the patent document or the patent disclosure, as it appears in the United States Patent and Trademark Office publicly available file of records, but otherwise reserves all copyright rights whatsoever. The copyright owner does not hereby waive any of its fights to have this patent document maintained in secrecy, including without limitation its rights pursuant to 37 C.F.R., section 1.14.

### FIELD OF THE INVENTION

The present invention generally relates to advertising in the sports, and more specifically, to advertising in the sports using sport shirts.

### BACKGROUND OF THE INVENTION

Sports, such as, but not limited to, European football known as a soccer, American football, basketball, volleyball, hockey, etc, are widely spread activities that generates lots of revenues for the teams and sponsors with lots of joy for sport fans. The teams have sponsors that support the sport and helping them to have more revenues. Because of that, the teams offer its players shirts/jerseys as an advertising medium to its sponsors products and services. Shirts as an advertising medium are very effective medium for the companies because they can be recognized by any sport fan world wide as much the team is recognized.

The sports fan are playing big part of the game with its attendance at the stadiums, with their purchasing the team products and services, giving open support to its team, etc. The sports sponsors want to be more closely related to the team sport fans, because they both are supporters of the same team. The sponsors are trying to reach the sport fans in different ways, with intention to advertise its products and services to them and sell the same. But what the sport fans get from the team and from the sponsors? Can they advertise them self too, so they can be part of the game? Can they send its opinion about the team and team sponsors?

Currently, there is a lack of a reliable structure and business model in the sport advertising where sport fan can advertise its self and/or to have relevant opinion about the team and its sponsors, which makes them more committed to the sport team and give them more satisfaction.

Therefore, an object of the present invention is to provide a new business model for advertising in sport events that will involved the sport fans and their needs. With implementing of this invention, the relation between the sport team, its sponsors and the team fans will be more compact, united and all will have a feeling that are part of a same team where all of them will get its satisfaction.

### BRIEF SUMMARY OF THE INVENTION

The general purpose of the present invention, which will be described subsequently in detail later, is to provide model of advertising of the sport fans in the team sport shirts, heretofore as a prior art and novel features that which is not anticipated, rendered obvious, suggested, or even implied by any of the prior art, either alone or in any combination thereof.

Moreover, one embodiment of the present invention includes one or more image badge(s) of sport fans associations and/or website addresses badge(s) of the sport fans associations and/or any other form of sport fans advertising placed on the permitted areas for that on the sport clothing/apparel, such as, but not limited to, the sleeve free zone on the soccer player shirt, as a Jacquard weave or similar techniques embedded into the player's clothing/apparel, such as, but not limited to embroidering, where team sport fans can advertise its fans organization.

Another embodiment of the present invention is that the team sport fans need to have own account on a recognizable team sport fans association website, where each team sport fan will get its own secure web page and/or secured personal e-mail fan address where he/she can receive information, filling out offered surveys and other activities known in the prior art of computer, internet, advertising, marketing, e-mailing and other relevant industries.

Another embodiment of the present invention is that the team sport fans may need to pay yearly membership for right to be part of the fan shirt/jersey advertising and receive certificate for that year by the sport team, where the certificate is closely related to the image badges and/or the website address badge and/or other ways of recognizing the fan associations advertised on the sport shirt/jersey player.

Another embodiment of the present invention is that every team sport fan receive unique code that shows his/her membership for that year, where he/she can use that personal secure unique code for discounts from the sport sponsors products and services, can send information with its opinion about the game, ideas about the team, and the like, as is already known in the prior art of advertising, marketing, business and other relevant industries.

Another embodiment of the present invention is that a special credit card may be issued to the fans, where every purchase by the fan will bring more revenue to the fan's account, so the fan can use the revenue to cover traveling expenses for watching the games and other its needs, as is already known in the prior art of banking, business and other relevant industries.

Another embodiment of the present invention includes right of the sport team to contact team sport fans with surveys of questions related to the personal life of the team sport fan, to know more about its needs and to offers a solutions for their needs with offering services and products from its relevant sponsors.

Another embodiment of the present invention includes the team sport fan who lives in the area where team sport sponsor do not have developed its business yet, the team sport sponsor may sale its right to the companies that do local business around the address of living of the team sport fan, offering the discounts and other products and services as is known in the prior art in the business industry and other related industries.

Another embodiment of the invention is a apparel/clothes created by the team for the fans with all companies that support its team together with the badge(s) of the fan associations, and/or other way of representing the fan association(s), along with or without the advertising logos and other information from the companies, where that apparel/clothes may be used for the game or not.

In this respect, before explaining at least one embodiment of the invention in greater detail, it is to understand that invention is not limited in its application to the details and steps of construction and to arrangements of the components/steps set forth in the following description. This invention is capable of other embodiments and of being practiced and carried out in various ways. In addition, it is to be understood that the phraseology and terminology employed herein is for the purpose of description and should not be regarded as limiting.

As such, those skilled in the art will appreciate that the conceptions, upon which this disclosure is based, may readily be utilized as a basis for the designing of other structures, devices, methods and systems for carrying out several purposes of the present invention. It is important, therefore, that the claims be regarded as including such equivalent constructions insofar as they do not depart from the spirit and scope of the present invention.

Further, the purpose of the foregoing abstract is to enable the Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application not is it intended to be limiting as to the scope of the invention in any way.

### DEFINITIONS OF TERMS AND THEIR INTERPRETATIONS

The term “advertising” herein denotes any form of advertising information, such as, but not limited to, any designation, message, logo, trademark, name or emblem of any nature, that may be placed adequately and successfully on the sport clothing and any other form of advertising known in the prior art in advertising industry.

The term “sport clothing/apparel” herein denotes sport clothing of the player, club or match officials, such as, but not limited to shirts, shorts, socks, under shorts, t-shirts, any other item worn under the shirt, sweat-bands, headbands, caps tracksuits, gloves, sweat tops, sock tie-ups, football boots, and any other clothing that sportiest use in their activities.

The term “team sport fan” and “sport fan/sport fans” herein denotes person who is fan of the team that play any known sport, where person is the physical and/or spiritual supporter of the team as is known in the prior art of the sport.

### DETAILED DESCRIPTION OF THE PREFERRED EMBODIMENTS

Aspects of the invention may be practiced using any suitable arrangement of the elements of the invention. Several different embodiments are described for purposes of illustration herein.

The invention, as an embodiment includes one or more image badges of sport fans associations and/or website addresses badge(s) of the sport fans associations and/or any other form of sport fans advertising placed on the permitted areas for that on the sport clothing/apparel, such as, but not limited to, the sleeve free zone on the soccer player shirt, as a Jacquard weave or similar techniques, such as, but not limited to embroidering embedded into the player's clothing/apparel, where team sport fans can advertise its fans organization. In this way, the fan can be represented on the player's apparel. In order to reach more sport fans, the sponsor may include the fan association on its badge along with own advertising. For example, the fan badge may include information such as, but not limited to, logo of the fan association and/or website address. Since “Barclay” is sponsor of the English Premier Football League for all football teams in the Premier League, the “Barclay” may bring all fans from all the teams together and offers its services and products to them.

Another embodiment of the invention may implement the same method explained in [0025] to each of the soccer team. For example, the fan badge may have included information such as, but not limited to, logo of the fan association and/or website address. Since “Inter” has its own fans and sponsors that support it, they may bring all fans together and offers those services and products from the “Inter” sponsors to “Inter” fans association.

Another embodiment of the present invention is that the team sport fans need to be official member to the fan association recognized by all relevant associations for money or for free, where the fan must to open secure and personal account on a team sport fans association website, where each team sport fan will get its own secure web page and/or own e-mail address, where fan can receive information, filling out offered surveys and other activities known in the computer, interne, e-mailing, advertising, marketing and other relevant industries. In this way the team sponsors can communicate adequately and successfully with the team fans.

Another embodiment of the present invention is that a special credit card may be issued to the fans, where every purchase by the fan will bring more revenues to the fan account, where the fan can use that revenue to cover traveling expenses for watching the games or other fan needs. The fan will have additional exclusive privileges from the sponsor' products and services as long he/she is legally and officially member of the fan association that does relate to the sponsors, as is already known in the prior business, banking and other relevant industries.

Another embodiment of the present invention is that the team sport fans may need to pay yearly membership for right to be part of the fan clothes/apparel advertising and receive certificate for that year by the sport team and/or sport team sponsor(s), where the certificate is closely related to the badges and/or other ways of representing the fan associations, advertised on the sport clothing/apparel of the player. The fan may also have a right to sent its personal opinion about the team, team games, team sponsors and the like, where the fan's voice may be taken in considerations.

Another embodiment of the present invention includes right of the sport team and sport team sponsors to contact team sport fans with surveys of questions related to the personal life of the team sport fan, to know more about its needs and to offers a solutions for their needs. If the team sport fan lives in the area where team sport sponsor do not have developed its business yet, the team sport sponsor may sale its right to the companies that do local business around the address of living of the team sport fan, offering the discount and other products and services as is known in the prior art in the business industry and other related industries. The team sport sponsors may also pay the team sport for developing local marketing around the residence address of living of the team sport members.

Another embodiment of the invention is a apparel/clothes created by the team for the fans with all companies that support its team together with the badge(s) of the fan associations, and/or other way of representing the fan association(s), along with or without the advertising logos and other information from the companies, where that apparel/clothes may be used for the game or not.

Another embodiment of the present invention is that every team sport fan receive unique code that shows his/her membership for that year, where he/she can use that personal secure unique code for discounts from the sport sponsors products and services, can send information with its opinion about the game, ideas about the team, and the like, as is already known in the prior art of advertising, marketing, business and other relevant industries.

Having described the principles of my invention, it should be apparent that these embodiments of the invention are basic embodiments and that more embodiments may be added within the invention. From the foregoing, it will be appreciated that, although specific details and embodiments of the invention have been described herein for the purposes of illustration, various modifications may be made without deviating from the spirit and scope of the invention. Accordingly, I claim all embodiments and modifications as many come within the scope and the spirit of the following claims.

1. Advertising method on sport clothing comprising:
(a) creating an image badge(s) and/or website address badge(s) of a sport team fan association and/or other form of representing the sport team fan association(s);
(b) an image badge(s) and/or website address badge(s) of a sport team fan association may be embodied on the sport playing clothing/apparel, where is allowed by the official rules and regulations;
(c) sport team fan must to be member of the officially recognized sport team fan association, where sport team fan(s) receive a secure and unique personal web page and/or secure and unique personal e-mail address, as a part of the secure fan association website;
(d) the sport team fan association is officially recognized by the sport team and its sponsors;
(e) the sport team sponsors may communicate without limits with the members of the sport team fan association and the sport team fans, offering them its products and services;
(f) the sport team sponsors and/or sport team may offer discounts for its products and services to the sport team fans;
(g) the sport team sponsor(s) and/or the sport team may include its fans to their badge design(s);
(h) the sport team fans association may be advertised on any sport clothing/apparel that team and/or sponsor(s) created for the fans;
(i) the sport team sponsor(s) may sell its rights to business(es) who have a subcontract with them;
(j) the sport team and/or sport team sponsors may offer a special credit card and the like to its fan(s).

2. A method as recited in claim 1, wherein said sport team fan association further includes:
(a) sport team fan(s) that are at least 18 years old and supporters of the sport, where every sport team fan must to be official member of the sport team fan association, as is known in the prior art of the relevant industries;
(b) one or more image badges of sport team fans associations and/or website addresses badge(s) of the sport team fans associations and/or any other form of sport team fans advertising placed on the permitted areas for that on the sport clothing/apparel, such as, but not limited to, the sleeve free zone on the soccer player shirt, as a Jacquard weave or similar techniques embedded into the player's clothing/apparel, such as, but not limited to embroidering;
(c) the sport team fans that needs to be official member to the sport team fan association recognized by all relevant associations for money or for free, where the sport team fan must to open secure and personal account on a sport team fans association website, where each sport team fan will get its own secure web page and/or own secure e-mail address, where sport team fan can receive information, filling out offered surveys and other activities known in the computer, interne, e-mailing, advertising, marketing and other relevant industries;
(d) sport team fan association(s) members may communicate adequately and successfully with the sport team and/or with the sport team sponsors as is known in the prior art in communication industry;
(e) sport team fan association may be represented by any word(s), number(s) color(s), design(s) and the like, and any combination between them that are related to the meanings of the sport team fan association(s).

3. A method as recited in claim 1, wherein said sport team fan further includes:
(a) sport team fan(s) that a receives a special credit card by the sport team and/or sport team sponsors, where every purchase by the sport team fan will bring more revenues to the sport team fan account, where the sport team fan can use that revenue to cover traveling expenses for watching the games or other sport team fan needs, and the sport team fan will have additional exclusive privileges from the sport team sponsor' products and services as long the sport team fan is legally and officially member of the sport team fan association that does relate to the sponsors, as is already known in the prior business, banking and other relevant industries;
(b) sport team fan that may need to pay yearly membership for right to be part of the sport team fan clothes/apparel advertising and receive certificate for that year by the sport team and/or sport team sponsor(s), where the certificate is closely related to the badge(s) and/or other ways of representing the sport team fan associations, advertised on the sport clothing/apparel of the player, which give the fan to have a right to sent its personal opinion about the team, team games, team sponsors and the like, where the fan's voice may be taken in considerations, as is known in the prior art of the related industries;
(c) sport team fan that receive unique code that shows his/her membership for that year, where sport team fan can use that personal secure unique code for discounts from the sport team sponsors products and services, can send information with its opinion about the game, ideas about the team, and the like, as is already known in the prior art of advertising, marketing, business and other relevant industries;

4. A method as recited in claim 1, wherein said sport team and/or sport team sponsors further includes:
(a) right of the sport team and/or sport team sponsors to contact team sport fans with surveys of questions related to the personal life of the sport team fan, to know more about its needs and to offers its products and services as a solutions for fan needs, as is known in the prior art in the business and other relevant industries;
(b) sport team and/or sport team sponsors to sale its right to the companies that do local business around the address of living of the sport team fan where the main sport team sponsors do not have developed its business, offering products and services to the sport team fan(s) as is known in the prior art in the business industry and other related industries;
(c) sport team and/or sport team sponsors that creates an apparel/clothes for the fans with all companies that support its team together with the badge(s) of the fan associations, and/or other way of representing the fan association(s), along with or without the advertising logos and other information from the companies, where that apparel/clothes may be used for the game or not.
